(19) United States
(12) Patent Application Publication
(10) Pub. No.: US 2004/0190803 A1
(43) Pub. Date: Sep. 30, 2004

(54) Wear-resistant polymeric bushing for biopharmaceutical applications

(76) Inventor: Prasanna Avinash Deshpande, Raleigh, NC (US)

Correspondence Address: WOMBLE CARLYLE SANDRIDGE & RICE, PLLC, P.O. BOX 7037, ATLANTA, GA, 30357-0037, US

(21) Appl. No.: 10/401,660

(22) Filed: Mar. 28, 2003

(51) Int. Cl. F16C 33/20; F16C 33/18

(52) U.S. Cl. 384/297

(57) ABSTRACT

A polymeric bushing is disclosed. The bushing may be constructed of a material comprising polyetheretherketone (PEEK), glass fibers, and polytetrafluoroethylene (PTFE). In one embodiment, the bushing material includes about 70% PEEK, about 20% glass fibers, and about 10% PTFE by weight. An inner bore in the bushing may be sized to provide a diametrical clearance of about 0.025 inch with a mating rotating shaft. The bushing is durable and wear-resistant, and exhibits low extractables and cytotoxicity. Accordingly, the bushing is particularly suited for use in equipment for processing blood products or the like. The bushing is especially useful for supporting a rotating boss sleeve on a separation rotor in a tubular centrifuge.

### FIELD OF THE INVENTION

The invention relates to bearings, and more specifically, to bushings for supporting rotating shafts in rotating machinery.

### BACKGROUND

Bushings are commonly used in rotating machinery to support rotating shafts, spindles, and the like. Typically, bushings are removable components in the form of one-piece sleeves or rings that form a liner in a support for a rotating shaft, thereby providing a bearing surface for the shaft. Bushings typically have a central opening or bore that is slightly larger than a mating outer diameter of the rotating shaft. The diametrical clearance between the bore of the bushing and the outer diameter of the shaft is controlled to provide adequate clearance to permit rotation of the shaft while also providing adequate alignment and support of the shaft. Bushings are often constructed of soft metals (such as brass, bronze, or the like), graphite-filled sintered metal, polymeric materials such as nylon or fluoropolymers, or the like. The bushing material is preferably softer than the material of the mating rotating shaft so that the majority of any resultant abrasive wear or scouring between the shaft and bushing is borne by the disposable bushing rather than the shaft.

Bushings are commonly used in rotating equipment such as tubular centrifuges. Tubular centrifuges are used for the continuous high-speed separation of a mixture of flowable materials having different densities. Such centrifuges are commonly used in separation processes applied in the fields of biochemistry, pharmaceuticals, foods and beverages, paints and chemicals, blood products, and the like. A cross-sectional view of a typical tubular centrifuge 10 is shown in FIG. 1.

The principal components of a typical tubular centrifuge are a casing 8, a separation rotor or “bowl” 12 having a cylindrical boss sleeve 14 at its base, a drive spindle 16, an effluent collector 18, and a boss sleeve support or “drag assembly” 20. The drag assembly 20 remains substantially stationary and provides lateral and rotational support for the boss sleeve 14 as the bowl 12 is rotated at high speeds by the drive spindle 16. A mixture of a lighter first material and a heavier second material is continuously passed into the bowl 12 through a central passage 22 in the drag assembly 20 and an opening 15 in the boss sleeve 14. As the bowl 12 rotates at a high speed (e.g. about 15,000 rpm). the heavier second material is forced radially outward as it passes upward in the bowl 12. Thus, the heavier second material is separated from the lighter first material. The lighter first material, on the other hand, remains in the radially central portions of the bowl 12 as the lighter material passes upward in the bowl 12. The lighter first material passes from the bowl 12 and into the effluent collector 18 where the first material is collected for further processing. The heavier second material is ultimately extracted from the centrifuge 10 by disassembling the bowl 12.

An enlarged cross sectional view of a lower portion of the tubular centrifuge 10 of FIG. 1 is shown in FIG. 2. As shown in this figure, boss 14 is supported in the drag assembly 20 by a bushing 30. Referring to FIG. 3, the bushing 30 has a central bore 32 for receiving a mating outer diameter of the boss sleeve 14 (not shown). The bushing 30 has an outer edge 34, and fits into a recess 40 in the drag assembly 20 as shown. Preferably, the outer edge 34 is slightly larger in width or diameter than the recess 40 in a free state, thereby forming a radial interference fit between the bushing 30 and the recess 40. Such an interference fit helps to retain the bushing 30 in a stationary position. The outer edge of the bushing 30 may also be keyed to the drag assembly 20 to provide a positive stop against rotation of the bushing 30. Alternatively, the outer edge 34 and recess 40 may have matching non-circular shapes to prevent relative rotation between the bushing 30 and the drag assembly 20.

Continuous tubular centrifuges of the type described above are used in the process of fractionation of blood products such as plasma protein fractionation. In this process, blood plasma from human donors is collected as a source of various useful proteins. Because these proteins are denser than the plasma effluent in which they are mixed, tubular centrifuges can be used to segregate these proteins for subsequent use in various pharmaceutical and medical applications. Because this procedure is used to fractionate large volumes of blood plasma, it is desirable to be able to continuously operate a tubular centrifuge for extended periods to maximize production efficiencies. The bushings 30 described above are often a critical component or a “weakest link” in the plasma protein fractionation production process. As the bushings 30 experience wear from friction between the bushings 30 and the rotating boss sleeve 14, the rotational alignment of the bowls 12 degrades. Once such wear of a bushing 30 and the resultant diametrical clearance with the rotating boss sleeve 14 becomes excessive, the rotating bowl 12 can become unstable. As a result, the process must be interrupted, and the bushing 30 must be replaced to restore satisfactory support and alignment of the bowl. In some cases, bushing failure can result in substantial damage to other portions of a centrifuge, thereby causing even further production delays. Such interruptions create obvious inefficiencies in production. Therefore, there is a need for a bushing 30 that is durable and wear-resistant for use in a rotating apparatus such as a tubular centrifuge.

In addition, bushings 30 that are used in tubular centrifuges for the fractionation of blood products should comply with good manufacturing practices (GMPs) such that the production process does not compromise the quality, purity, or safety of the blood products they may contact. Specifically, such bushings 30 should not release undesirable materials (“extractables”) into the product materials during their use. In addition, such bushings should be constructed of materials that do not exert a cytotoxic effect on cells that are exposed directly or indirectly to the bushings 30. Though it is known to use hardwood bushings impregnated with a lubricant in tubular centrifuges, and though such bushings often exhibit at least satisfactory wear-resistance and durability, these wooden bushings may not satisfy one or both of these GMP criteria. Therefore, there is a need for an improved bushing for use in a tubular centrifuge that satisfies both a minimum extractables and minimum cytotoxicity criteria for use with blood products.

### SUMMARY

The invention includes a wear-resistant bushing for supporting a rotating cylindrical member in a high-speed rotating apparatus. The bushing is particularly useful for supporting a rotating boss sleeve on a bowl of a tubular centrifuge. The bushing may be constructed of a material comprising polyetheretherketone (PEEK), glass fibers, and polytetrafluoroethylene (PTFE). In one embodiment, the bushing is constructed of a material comprising about seventy percent PEEK by weight, about twenty percent glass fibers by weight, and about ten percent PTFE by weight. Such an embodiment of a bushing meets applicable United States Pharmacopeia (“USP”) guidelines for use in processing blood products. An embodiment of a bushing according to the invention may also include a central bore having a diameter that provides a diametrical clearance of about 0.025 inch with a mating outer diameter of a rotating shaft or boss. A tubular centrifuge comprising a bushing like that summarized above is also disclosed.

These and other aspects of the present invention as disclosed herein will become apparent to those skilled in the art after a reading of the following description of the preferred embodiments when considered with the drawings.

### DESCRIPTION OF THE DRAWINGS

FIG. 1 is a cross-sectional elevation view of a typical tubular centrifuge;

FIG. 2 is an enlarged cross-sectional elevation view of the lower portion of the tubular centrifuge shown in FIG. 1;

FIG. 3 is a cross-sectional elevation view of a drag assembly in the tubular centrifuge of FIGS. 1 and 2;

FIG. 4 is a perspective view of a polymeric bushing according to the invention;

FIG. 5 is a top plan view of the bushing of FIG. 4; and

FIG. 6 is a side view of the bushing of FIGS. 4 and 5.

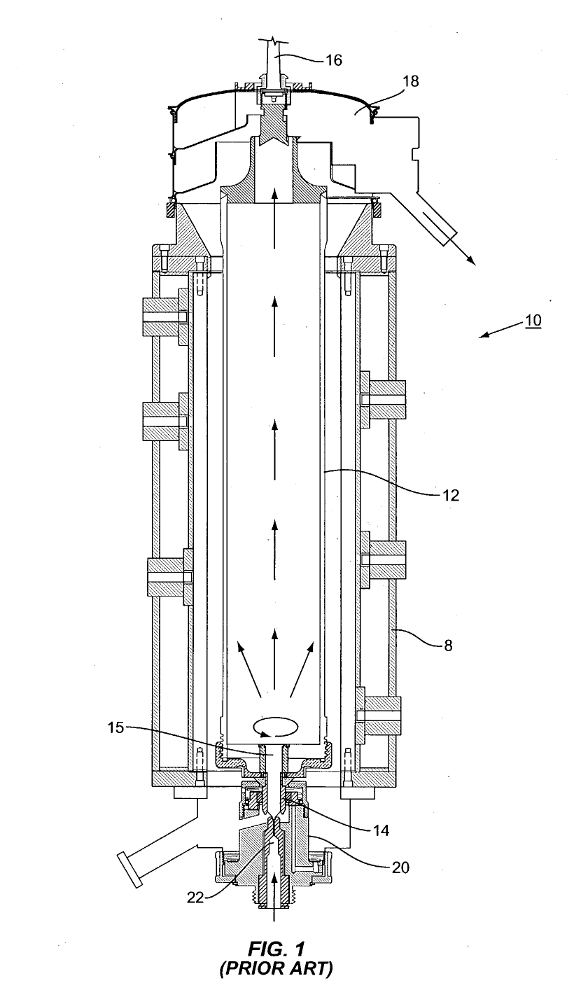

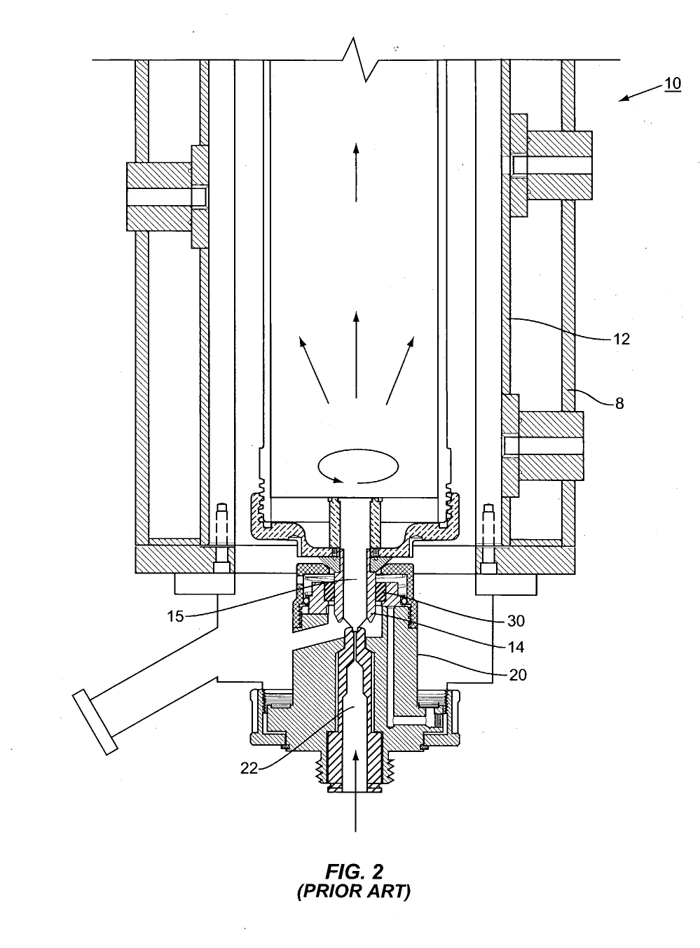

### DETAILED DESCRIPTION

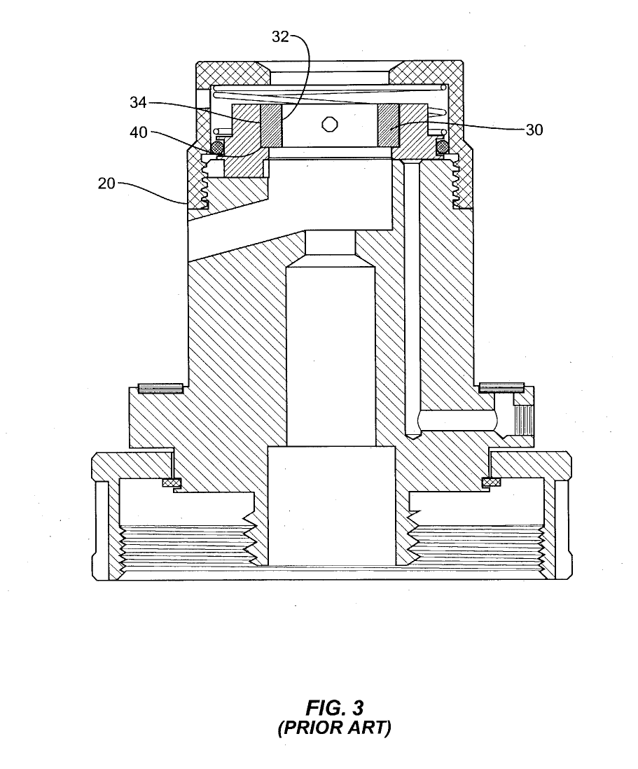

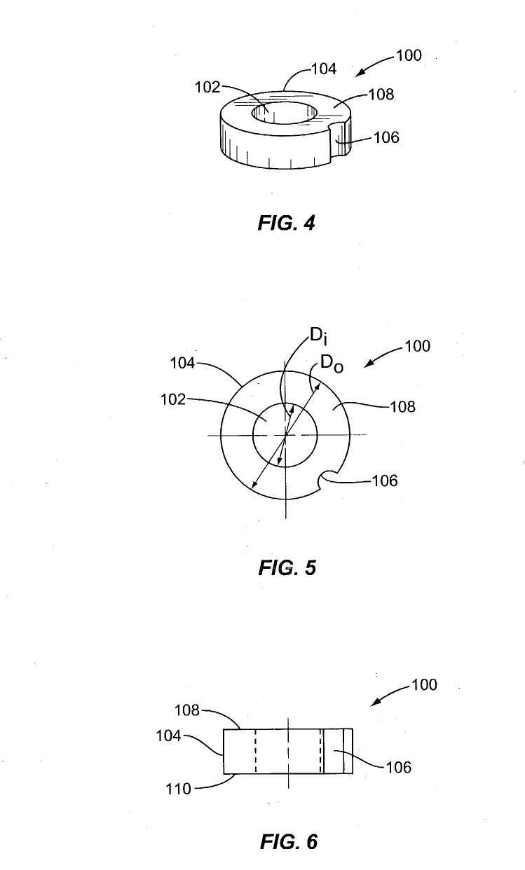

As shown in FIGS. 4-6, one embodiment of a bushing 100 according to the invention includes a circular inner bore 102, an outer edge 104, a first face 108, and a second face 110. As shown, the inner bore 102 has an inner diameter Dᵢ. The outer edge 104 may have a circular outer shape having an outer diameter Dₒ. An anti-rotation notch 106 may be provided in the outer edge 104. The anti-rotation notch 106 is sized and shaped to engage a key member in a drag assembly (not shown), thereby preventing relative rotation between the bushing 100 and the drag assembly 20. Alternatively, the outer edge may have a non-circular outer shape (not shown) that corresponds to a non-circular shape of a receiving recess 40 in a drag assembly 20 (not shown), thereby preventing relative rotation of the bushing 100. For example, the bushing 100 may have a square outer shape corresponding to a square-shaped recess in a drag assembly. The outer diameter Dₒ of the bushing 100 may be sized to be slightly larger than a corresponding diameter of a mating recess 40 in a drag assembly 20 to provide a tight interference fit between the bushing 100 and the mating recess 40.

The bushing 100 may be constructed from a polymeric material comprising polyetheretherketone (PEEK), glass fibers, and polytetrafluoroethylene (PTFE). In one embodiment, the bushing 100 is constructed of a material comprising about seventy percent PEEK by weight, about twenty percent glass fibers by weight, and about ten percent PTFE by weight. This composition has demonstrated a superior combination of strength, wear-resistance, thermal stability, and heat-resistance compared to other tested materials for the bushing 100. Other materials tested include glass-filled PEEK (without PTFE), polyimide (Vespel® SP-21), polyetherimide (Ultem®), Glass-filled Teflon®, and Kevlar®. Bushings constructed of hardwood (New England Rock Maple) impregnated with lubricating oil were also tested to establish a reference point for evaluating the performance of these various materials.

It is believed that the weight percentages of constituent materials stated above can vary by as much as about ±10% without adversely affecting the performance characteristics of the bushing. Therefore, the bushing material may comprise between about 67% to about 77% PEEK by weight, between about 18% to about 22% glass fibers by weight, and between about about 9% to about 11% PTFE by weight.

The bushing 100 has been found to perform acceptably in a tubular centrifuge rotating at speeds of up to about 15,000 rpm. Frictional wear of the inner bore 102 of the bushing 100 appears to be minimized or within acceptable limits when the diametrical clearance between the inner diameter Dᵢ and a mating outer diameter of a rotating cylindrical boss is between about 0.021 inch and about 0.029 inch, with an average diametrical clearance of about 0.025 inch. Testing indicates that a tubular centrifuge with a polymeric bushing according to the invention can be continuously operated for about seventy-two hours. This is at least about a 100% increase in operating life over previously used wooden bushings. Wooden bushings have typically required replacement after about thirty-six hours of continuous operation. The frequency of centrifuge failures that are attributable to bushing wear/failure is also significantly reduced through use of the new polymeric bushings.

The selected bushing material has been shown to meet applicable USP guidelines for both extractables content and cytotoxicity. Accordingly, the bushing 100 can be used in a tubular centrifuge for processing blood products without adversely affecting the quality, purity, or safety of the blood products.

While this invention has been illustrated and described in accordance with preferred embodiments, it is recognized that variations and changes may be made therein without departing from the invention as set forth in the claims. Certain modifications and improvements will occur to those skilled in the art upon a reading of the forgoing description. By way of example, while the bushing has been described as used in a tubular centrifuge, the bushing may also be applied in other types of rotating equipment. It should be understood that all such modifications are not contained herein for the sake of conciseness and readability, but are properly within the scope of the following claims.

what is claimed is:

1. A wear-resistant bushing for supporting a rotating cylindrical member of a high-speed rotating apparatus, the bushing comprising:
(a) a bore having an inner diameter; and
(b) an outer edge;
wherein the bushing is constructed of a material comprising polyetheretherketone, glass fibers, and polytetrafluoroethylene.

2. A bushing according to claim 1 wherein the high-speed rotating apparatus is a tubular centrifuge and the rotating cylindrical member is a substantially cylindrical boss sleeve on a lower end of a rotating centrifuge bowl.

3. A bushing according to claim 1, wherein the inner bore has an inner diameter that is between about 0.021 inch and about 0.029 inch greater than a mating outer diameter of the rotating cylindrical member.

4. A bushing according to claim 1, wherein the outer edge is substantially circular and includes at least one anti-rotation notch along its circumference.

5. A bushing according to claim 1, wherein the bushing material comprises about seventy percent polyetheretherketone by weight.

6. A bushing according to claim 1, wherein the bushing material comprises about twenty percent glass fibers by weight

7. A bushing according to claim 1, wherein the bushing material comprises about ten percent polytetrafluoroethylene by weight

8. A bushing according to claim 1, wherein the bushing material comprises about seventy percent polyetheretherketone by weight, about twenty percent glass fibers by weight, and about ten percent polytetrafluoroethylene by weight.

9. A bushing according to claim 1, wherein:
(a) the inner diameter of the inner bore is between about 1.18 and about 1.20 inch;
(b) the outer edge is substantially circular and includes at least one radial recess therein; and
(c) the bushing material comprises about seventy percent polyetheretherketone by weight, about twenty percent glass fibers by weight, and about ten percent polytetrafluoroethylene by weight.

10. A tubular centrifuge comprising;
(a) a separation rotor having a substantially cylindrical boss sleeve extending from a first end of the rotor;
(b) a boss sleeve support for rotatably supporting the boss sleeve;
(c) a bushing mounted in the boss sleeve support, the bushing having an inner bore for receiving a mating outer diameter of the boss sleeve, the bushing being constructed of a material comprising polyetheretherketone, glass fibers, and a fluoropolymer.

11. A tubular centrifuge according to claim 10 wherein the fluoropolymer is polytetrafluoroethylene.

12. A tubular centrifuge according to claim 10 wherein the inner bore of the bushing is about 0.025 inch larger than the mating outer diameter of the boss sleeve.

13. A tubular centrifuge according to claim 10 further comprising an anti-rotation means that substantially prevents relative rotation between the bushing the boss sleeve support.

14. A tubular centrifuge according to claim 13 wherein the bushing includes a substantially circular outer edge and the anti-rotation means includes a notch in the outer edge of the bushing and a mating key in the boss sleeve support.

15. A tubular centrifuge according to claim 10 wherein the bushing material comprises about seventy percent polyetheretherketone by weight, about twenty percent glass fibers by weight, and about ten percent polytetrafluoroethylene by weight.

16. A tubular centrifuge according to claim 10 wherein the rotational speed of the separation rotor is between about 0 rpm and about 15,000 rpm.

17. A wear-resistant bushing for a rotatably supporting a rotating boss on a bowl of a tubular centrifuge, the bushing comprising:
(a) a substantially circular outer edge having at least one anti-rotation notch therein; and
(b) a central bore having a diameter that is between about 0.021 inch and about 0.029 inch larger than a mating outer diameter of the rotating boss sleeve;
wherein the bushing is constructed of a material comprising about seventy percent polyetheretherketone by weight, about twenty percent glass fibers by weight, and about ten percent polytetrafluoroethylene by weight.
